(19) United States
(12) Patent Application Publication
(10) Pub. No.: US 2007/0136269 A1
(43) Pub. Date: Jun. 14, 2007

(54) Information monitoring method

(76) Inventors: Takashi Yamakabe, Yokohama (JP); Shuji Fujino, Ayase (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/360,588

(22) Filed: Feb. 24, 2006

(30) Foreign Application Priority Data
Nov. 28, 2005 (JP) 2005-341777

(51) Int. Cl. G06F 17/30

(52) U.S. Cl. 707/4

(57) ABSTRACT

A method of monitoring information of a plurality of computers including converting item identification information in an acquisition request for performance information into item identification information of a target computer as a monitoring target and transmitting by a communication device the converted acquisition request to the target computer; obtaining, for an item indicated by the item identification information in the converted acquisition request, performance information of the target computer and transmitting by a communication device the performance information to the target computer; and obtaining item identification information and a unit from performance information transmitted from the target computer, converting the item identification information and the unit into item identification information and a unit of a device on an acquisition request side having issued the acquisition request, and transmitting by a communication device the item identification information and the unit thus converted to the device on the acquisition request side.

### INCORPORATION BY REFERENCE

The present application claims priority from Japanese application JP 2005-341777 filed on Nov. 28, 2005, the content of which is hereby incorporated by reference into this application.

### BACKGROUND OF THE INVENTION

The present invention relates to an information monitoring technique for handling, when monitoring information of a plurality of computers, units and names of performance information and capacity information in a unified manner.

There exists a method to manage, in a unified manner, management items to be managed in an operation managing system. For example, JP-A-2002-7231 describes a technique for an information managing system, the technique being applied to operation management in a computer system and/or a network system in a firm and/or a factory. A large number of computer terminals and network devices exist on such a network. To manage the computer terminals and the network devices, there are required managing ledgers including an information device managing ledger, a software managing ledger, an address managing ledger, and a vendor managing ledger. Although these managing ledgers include, depending on cases, data items which have mutually different item names and which are equal in the contents thereof to each other, the item names are not integrally handled in all managing ledgers. To solve the problem, the item names indicating the same contents are related to each other to refer to the same value to thereby manage the data in a unified manner.

### SUMMARY OF THE INVENTION

For the operation management, there also exist items having units such as performance information and capacity information of a computer system. In the operation management only for the same vendor and the same product, it is not required to pay attention to the unit. However, in an environment in which the operation management is conducted for a plurality of vendors or in which the operation management is conducted for the same vendor and mutually different operation management products, the unit differs between the same item name in some cases. In this case, an administrator of Intelligent Technology (IT) resources or a job manager needs to conduct the operation by paying attention to the units. For the performance information and the capacity information, there possibly exists a case in which mutually different item names indicate the same item and the units thereof differ from each other. This situation cannot be coped with the prior art.

It is therefore an object of the present invention to provide an information monitoring method capable of conducting, in an environment in which a plurality of operation management schemes for different vendors exist on a network, the operation management schemes in a unified manner without paying attention to units and item names of data items unique to the operation management schemes.

According to the present invention, there is provided an information monitoring system to monitor information of a plurality of computers in which item identification information (an item identifier (ID) or name) and a unit in an acquisition request for performance information, performance information, or policy information to be communicated between devices during the operation to monitor the information of a plurality of computers are converted into item identification information and a unit of a device of a transmission destination before the item identification information and the unit are transmitted thereto.

In the information monitoring system of the present invention, during the operation to monitor information of a plurality of computers to be monitored such as job computers and a storage managing computer, when a system managing client or a job managing client sends an acquisition request for performance information of the job computers and the storage managing computer to a managing computer, a manager processing part of the managing computer refers to an information table by operation management having stored common performance identifiers, common units, and common performance item names by operation management corresponding to the operation management schemes of the job computers and the storage managing computer. The manager processing part then converts a common performance item identifier in the acquisition request for performance information into a performance item name by operation management of the job computers and the storage managing computer to send the converted acquisition request to the job computers and the storage managing computer.

Each of the agent processing parts of the job computers and the storage managing computer obtains, for an item indicated by the converted performance item name by operation management in the acquisition request, values of the job computer and the storage managing computer and then sends the values as performance information to the managing computer.

When the performance information is received from one of the job computers and the storage managing computer, the managing computer refers to the information table by operation management and a unit conversion table including each unit and a converted value of the unit to convert a performance item name by operation management and a unit in the received performance information into a common performance item identifier and a common unit of the system managing client and the job managing client on the acquisition request side and then sends the common performance item identifier and the common unit to the acquisition request side.

In the information monitoring system of the present invention, during the operation to set policy information indicating processing to be executed when a value of a predetermined item satisfies a threshold value condition to the job computers and the storage managing computer, when the system managing client or the job managing client sends policy information of the job computers and the storage computer to the managing computer, the manager processing part of the managing computer refers to the information table by operation management and the unit conversion table to convert a common performance item identifier and a common unit in the policy information into a performance item identifier and a unit of each of the job computers and the storage managing computer to send the converted policy information to the job computers and the storage managing computer.

Each of the agent processing parts of the job computers and the storage managing computer obtains, for an item indicated by the converted performance item name by operation management in the policy information, a value of each of the job computers and the storage managing computer to execute, if the value satisfies a threshold value condition corresponding to the item name, predetermined processing corresponding to the threshold value condition, for example, terminates an application or transmits a notification indicating that the threshold value condition is satisfied.

When the notification is received from one of the agent processing parts of the job computers and the storage managing computer, the managing computer refers to the information table by operation management and the unit conversion table to convert a performance item name by operation management and a unit in the received notification into a common performance item identifier and a common unit of the system managing client and the job managing client as the notification destinations and then sends the common performance item identifier and the common unit to the system managing client and the job managing client.

According to the present invention, in an environment including a plurality of different operation management schemes on a network, the operation management schemes can be conducted in a unified manner without paying attention to item identification information and units of performance information unique to the operation management schemes.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration example of an embodiment of an information monitoring system.

FIG. 2 is a diagram showing a logical configuration example of the embodiment of an information monitoring system.

FIG. 3 is a diagram showing an example of a computer managing table of the embodiment.

FIG. 4 is a diagram showing an example of a job table of the embodiment.

FIG. 5 is a diagram showing an example of an operation managing table of the embodiment.

FIG. 6 is a diagram showing an example of a computer operation managing table of the embodiment.

FIG. 7 is a diagram showing an example of a performance item table of the embodiment.

FIG. 8 is a diagram showing an example of an information table by operation management of the embodiment.

FIG. 9 is a diagram showing an example of a unit conversion table of the embodiment.

FIG. 10 is a diagram showing an example of a job threshold value table of the embodiment.

FIG. 11 is a diagram showing an example of a system managing threshold value table of the embodiment.

FIG. 12 is a diagram showing an example of a client managing table of the embodiment.

FIG. 13 is a diagram showing an example of a conversion processing flow of the embodiment.

FIG. 14 is a flowchart showing an example of a processing procedure of main processing in the embodiment.

FIG. 15 is a flowchart showing a processing procedure example of client request processing in the embodiment.

FIG. 16 is a flowchart showing a processing procedure example of policy information setting processing in the embodiment.

FIG. 17 is a flowchart showing a processing procedure example of name/unit setting processing in the embodiment.

FIG. 18 is a flowchart showing a processing procedure example of monitoring processing in the embodiment.

FIG. 19 is a flowchart showing a processing procedure example of event receiving processing of the embodiment.

FIG. 20 is a flowchart showing a processing procedure example of agent processing in the embodiment.

FIG. 21 is a flowchart showing a processing procedure example of performance item name conversion processing 1 in the embodiment.

FIG. 22 is a flowchart showing a processing procedure example of performance item name conversion processing 2 in the embodiment.

FIG. 23 is a flowchart showing a processing procedure example of unit conversion processing 1 in the embodiment.

FIG. 24 is a flowchart showing a processing procedure example of unit conversion processing 2 in the embodiment.

FIG. 25 is a flowchart showing an example of a job managing client screen of the embodiment.

### DESCRIPTION OF THE EMBODIMENTS

Next, description will be given of an embodiment of an information monitoring system to monitor information of a plurality of computers.

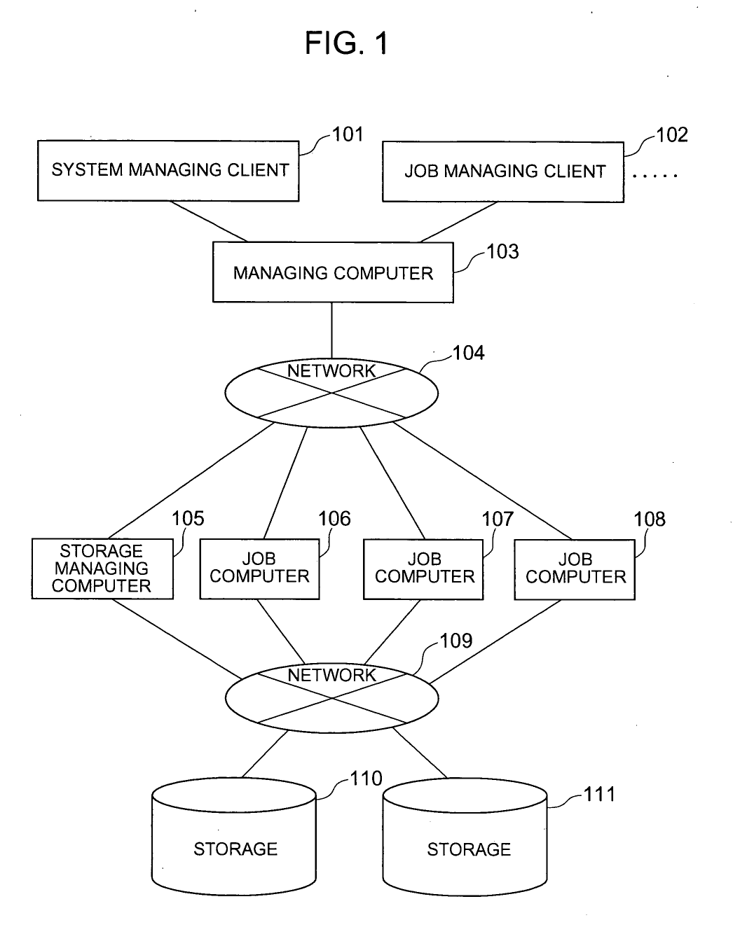

FIG. 1 is a diagram showing a configuration example of an information monitoring system of the embodiment. As shown in FIG. 1, in the information monitoring system of the embodiment, a managing computer 103, a storage managing computer 105, and job computers 106 to 108 are connected to a network 104. The job computers 106 to 108 are connected to a network 109 such as a Storage Area Network (SAN) dedicated to storages. Storages 110 and 111 are also connected to the network 109.

A system managing client 101 conducts operation, for example, obtains performance information of the storage managing computer 105 and the job computers 106 to 108 and sets a policy via the managing computer 103. A job managing client 102 conducts operation, for example, controls jobs and services, obtains performance information and capacity information of the job computers 106 to 108 and job applications (AP), and sets a policy via the managing computer 103. These clients may be a Graphic User Interface (GUI) which a manager operates via a screen and/or a GUI to monitor a service process and a business process using, for example, an Information Technology Infrastructure Library (ITIL) and a Service Oriented Architecture (SOA). Although the system managing client 101 and the job managing client 102 operate on the client computer, these clients 101 and 102 may operate also on the managing computer 103.

The system managing client 101 is operated by a system manager. The system manager is a manager of IT resources such as a computer, a storage, and a network and maintains and manages, for example, an operating system (OS) required to operate a job application and software programs (ITIL and SOA) which are a premise and/or a basis of the job application. The job managing client 102 is operated by a job manager. The job manager is a manager to maintain and to manage the job application and may also manage the job application developed and/or combined on the software programs such as ITIL and SOA used as a premise and/or a basis of the job application.

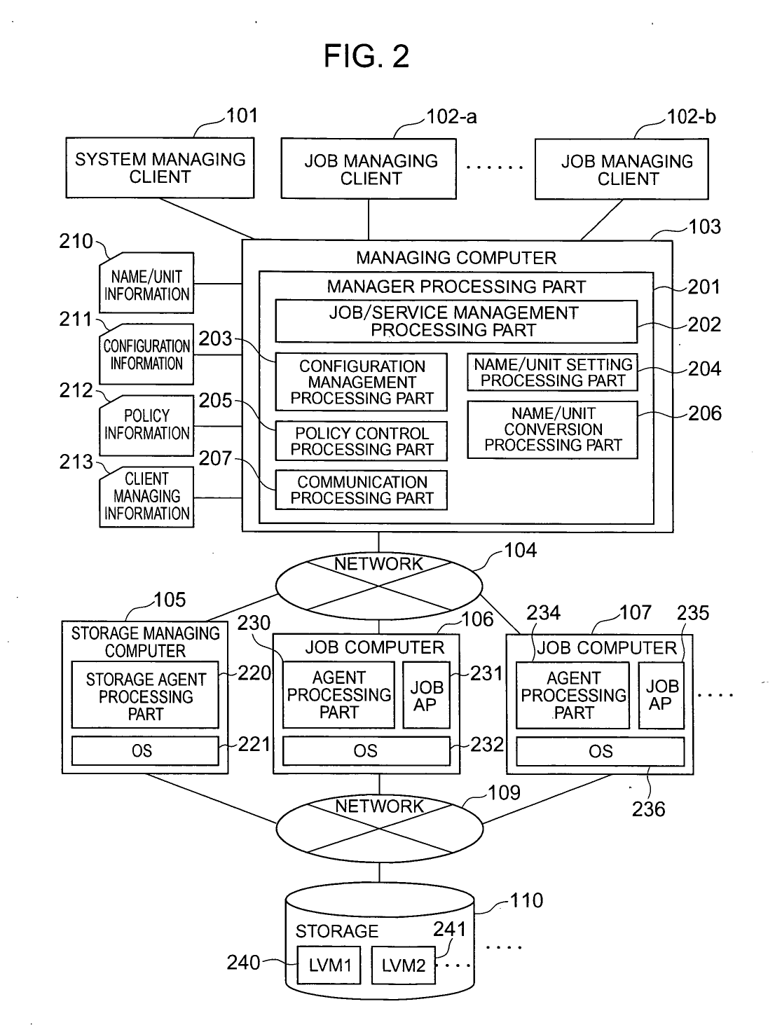

FIG. 2 is a diagram showing a logical configuration of the embodiment of an information monitoring system. As shown in FIG. 2, the managing computer 103 of the embodiment includes a manager processing part 201. The manager processing part 201 converts a common performance item name in a performance information acquisition request into a performance item name by operation management for the storage managing computer 105 and the job computers 106 to 108 and then sends the converted acquisition request by a communication device to the storage managing computer 105 and the job computers 106 to 108. The manager processing part 201 converts a performance item name by operation management and a unit in performance information sent from an associated one of the storage managing computer 105 and the job computers 106 to 108 into a performance item name and a unit common to devices on the acquisition request side and then sends the converted performance item name and the converted unit by a communication device to the system managing client 101 and the job managing client 102 (102-a, 102-b, etc). The manager processing part 201 converts a common performance item name and a common threshold value in policy information indicating processing to be executed when a value of a predetermined item satisfies a threshold value condition into a performance item name by operation management and a unit for an associated one of the storage managing computer 105 and the job computers 106 to 108 and then sends by a communication device to the storage managing computer 105 and the job computers 106 to 108. The manager processing part 201 converts the performance item name by operation management and the unit in the notation indicating that the threshold value condition is satisfied into a common performance item name and a common unit for the system managing client 101 and the job managing client 102 and then sends by a communication device the common performance item name and the common unit to the system managing client 101 and the job managing client 102. When the performance item name by operation management and the common unit in the acquisition request are substantially the same as those of the storage managing computer 105 and the job computers 106 to 108, the conversion is not required and hence is not conducted. The performance item name by operation management in the acquisition request is sent by a communication device to the storage managing computer 105 and the job computers 106 to 108.

It is assumed that a program which makes the managing computer 103 function as the manager processing part 201 is recorded in a recording medium such as a Compact Disk Read Only Memory (CD-ROM) to be stored in, for example, a magnetic disk. The program is thereafter loaded from the magnetic disk in a memory to be executed. The recording medium to record the program may be a recording medium other than a CD-ROM. The user may install the program from the recording medium in an information processing apparatus to thereby use the program. Or, the user may access the recording medium via a network to use the program.

The storage managing computer 105 includes a storage agent processing part 220. For an item indicated by the converted performance item name by operation management in the acquisition request, the storage agent processing part 220 obtains performance information of the storage managing computer 105 and sends the performance information by a communication device. Also, for an item indicated by the converted performance item name by operation management in the acquisition request, the storage agent processing part 220 obtains a value of the storage managing computer 105 and executes, if the value satisfies a threshold value condition corresponding to the item name, predetermined processing corresponding to the threshold value condition by a processing unit.

It is assumed that a program which makes the storage managing computer 105 function as the storage agent processing part 220 is recorded in a recording medium such as a CD-ROM to be stored in, for example, a magnetic disk. The program is thereafter loaded from the magnetic disk in a memory to be executed. The recording medium to record the program may be a recording medium other than a CD-ROM. The user may install the program from the recording medium in an information processing apparatus to thereby use the program. Or, the user may access the recording medium via a network to use the program.

The job computer 106 includes an agent processing part 230. For an item indicated by the converted performance item name by operation management in the acquisition request, the agent processing part 230 obtains performance information of the job computer 106 and sends the performance information by a communication device. Also, for an item indicated by the converted performance item name by operation management in the policy information, the agent processing part 230 obtains a value of the job computer 106 and executes, if the value satisfies a threshold value condition corresponding to the item name, predetermined processing corresponding to the threshold value condition by a processing unit.

It is assumed that a program which makes the job computer 106 function as the agent processing part 230 is recorded in a recording medium such as a CD-ROM to be stored in, for example, a magnetic disk. The program is thereafter loaded from the magnetic disk in a memory to be executed. The recording medium to record the program may be a recording medium other than a CD-ROM. The user may install the program from the recording medium in an information processing apparatus to thereby use the program. Or, the user may access the recording medium via a network to use the program.

The job computer 107 includes an agent processing part 234. For an item indicated by the converted performance item name by operation management in the acquisition request, the agent processing part 234 obtains performance information of the job computer 107 and sends the performance information by a communication device. Also, for an item indicated by the converted performance item name by operation management in the policy information, the agent processing part 234 obtains a value of the job computer 107 and executes, if the value satisfies a threshold value condition corresponding to the item name, predetermined processing corresponding to the threshold value condition by a processing unit.

It is assumed that a program which makes the job computer 107 function as the agent processing part 234 is recorded in a recording medium such as a CD-ROM to be stored in, for example, a magnetic disk. The program is thereafter loaded from the magnetic disk in a memory to be executed. The recording medium to record the program may be a recording medium other than a CD-ROM. The user may install the program from the recording medium in an information processing apparatus to thereby use the program. Or, the user may access the recording medium via a network to use the program.

The managing computer 103 includes the manager processing part 201. The manager processing part 201 includes a job-service management processing part 202, a configuration management processing part 203, a name/unit setting processing part 204, a policy control processing part 205, a name/unit conversion processing part 206, and communication processing part 207. The managing computer 103 includes name/unit information 210, configuration information 211, policy information 212, and client managing information 213.

The job computers 106, 107 include operating systems 232, 236, agent processing parts 230, 234, and job applications 231, 235, respectively. The other job computers are configured in almost the same way as for the job computer 106. The agent processing part 230 conducts operation, for example, collects performance information and capacity information of the operating system and the job application and monitors a threshold value for the performance information and the capacity information.

The storage managing computer 105 includes a storage agent processing part 230 and an operating system 221. The storage agent processing part 230 conducts operation, for example, collects performance information and capacity information of the storage 110 and monitors a threshold value for the performance information and the capacity information. The storage 110 includes Logical VoluMes (LVM) such as LVM1 240 and LVM2 241 which store therein data to be used by the job. The performance information and the capacity information may be collected in association with the storage 110 and may also be collected in association with the logical volumes.

Although not shown in the drawings, it is assumed that each of the computers and the clients includes programs which make the computer or the client function as each processing part, a Central Processing Unit (CPU) to execute programs such as a job application and an operating system, a memory in which the programs are to be loaded and in which data is temporarily stored at execution of a program, a magnetic disk device to store the programs and the information described above, an input device which conducts operation, for example, an operation to input an indication of operation and data; an output device which conducts operation, for example, an operation to output various information items, and a hardware resource such as a communication device to communicate with other computers and other clients.

The configuration management processing part 203 may be virtualized. In such a case, the virtual configuration may be implemented such that when viewed from the job manager, the job application cannot identify the job computers 106 and 107 in an operating state.

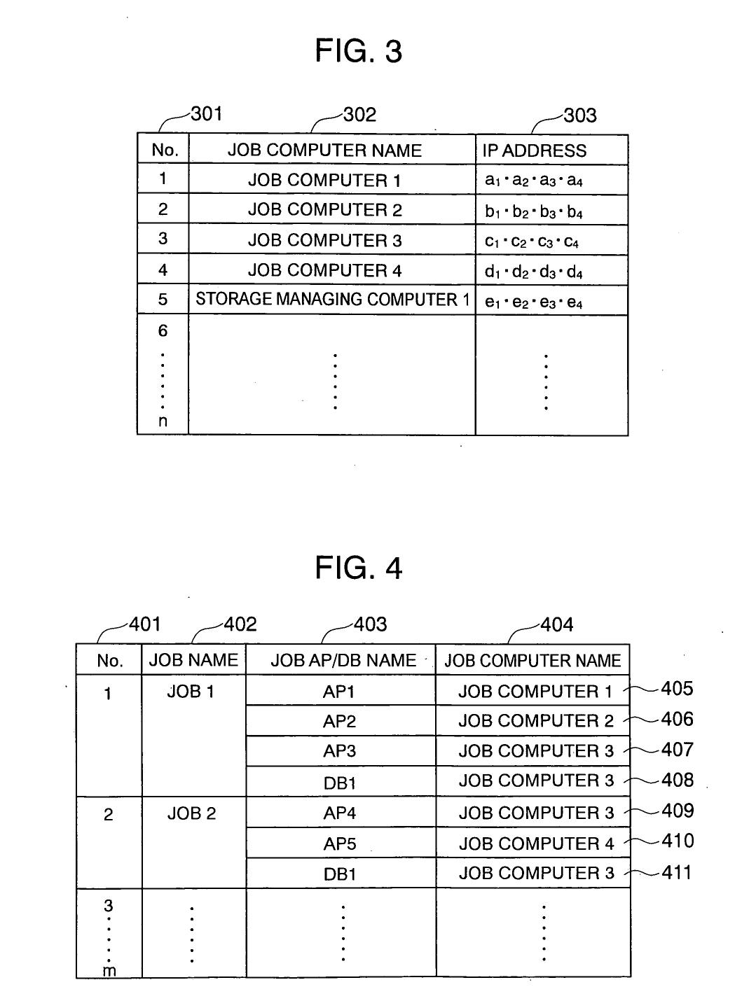

FIGS. 3 to 6 show details of the configuration information 211.

FIG. 3 shows an example of a computer managing table of the embodiment. 301 shows a serial number, 302 shows a job computer name, and 303 shows and IP address. FIG. 3 is a computer managing table to keep Internet Protocol (IP) addresses 303 of computers managed by the managing computer 103. According to the information, it is possible to identify locations of a job computer and a storage managing computer managed by the managing computer 103 to conduct communication therewith. There may exist a plurality of job computers and a plurality of storage managing computers. Therefore, when a computer is added/deleted or an IP address is changed, the configuration management processing part 203 automatically detects registration/deletion of a computer or change of an IP address to register/delete information to/from the computer managing table. In addition to the registration/deletion of information due to the automatic detection described above, the system manager may change information in the computer managing table.

FIG. 4 is a diagram showing an example of the job table in the embodiment. 401 shows a serial number, 402 shows a job name, 403 shows a job AP/DB name, and 404 shows a job computer name. FIG. 4 shows a table indicating for each job a relationship between each APplication (AP) or each DataBase (DB) and a job computer on which the application or the database is operating.

Depending on cases, one job uses one job computer or plural computers, and two or more jobs share one job computer. In FIG. 4, a job 1 includes AP1 (405) operating on a job computer 1, AP2 (406) operating on a job computer 2, AP3 (407) operating on a job computer 3, and DB1 (408) operating also on the job computer 3. A job 2 includes AP4 operating on a job computer 3 (409), AP5 operating on a job computer 4 (410), and DB1 operating also on the job computer 3 (411). The job 1 and the job 2 share the job computer 3.

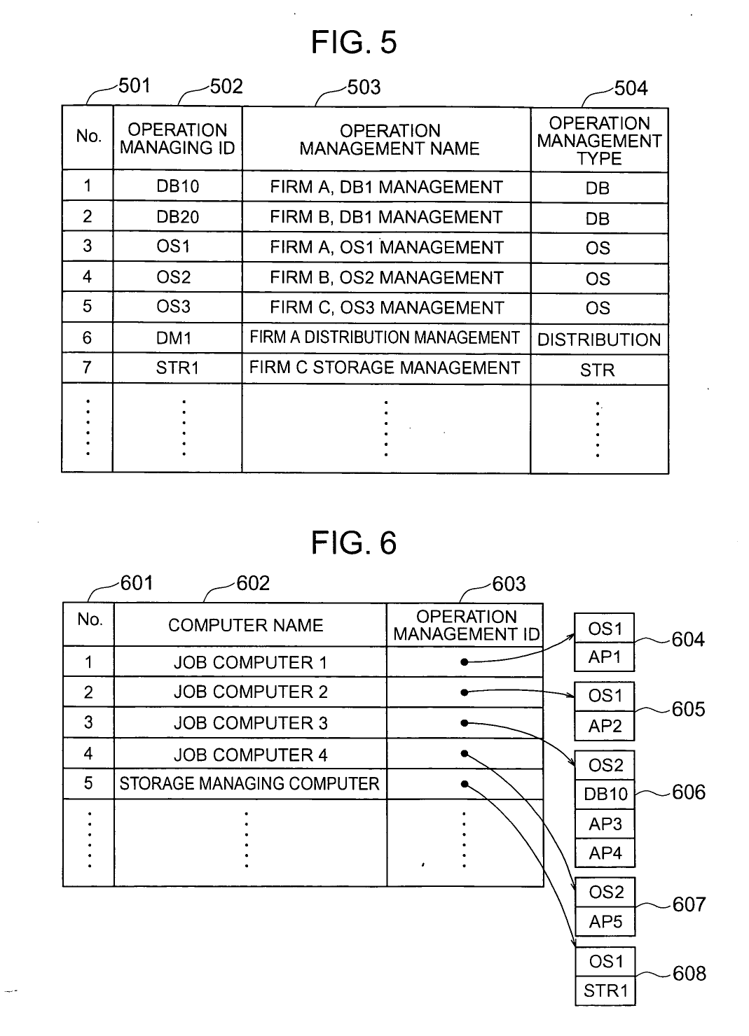

FIG. 5 is a diagram showing an example of an operation managing table of the embodiment. 501 shows a serial number. FIG. 5 shows a table to manage operation management and a type thereof. Each entry of the table keeps a type of operation management by maker and an ID according to each target to be monitored, for example, DB (database) management or OS management. The ID is a unique value, that is, when an operation management ID is determined, only one operation management name 503 is determined.

For example, No. 1 of FIG. 5 is operation management of firm A to manage DB1. No. 2 is operation management of firm B to manage DB1. No. 1 and No. 2 are operation management to manage DB1. Although an operation management type 504 is DB for No. 1 and No. 2, it is possible to identify by an operation management ID 502 whether the entry is the operation management of firm A or firm B. The operation management is an operation management program to monitor performance information and capacity information of an operating system, a database, a job, and a storage and is available as an operation management product in the market or is opened as an operation management tool to the public.

FIG. 6 is a diagram showing an example of a computer operation managing table of the embodiment. 601 shows a serial number, and 602 shows a computer name. FIG. 6 shows a table indicating operation management operating in each job computer.

Depending on cases, a plurality of operation management schemes are operating on one computer. For example, the case of No. 1 of FIG. 6 indicates that operation management schemes with the operation management ID of OS1 and AP1 (604) are operating on the job computer 1. Similarly, the cases of Nos. 2-5 indicate schemes of combinations of OS, AP, DB, STR, etc. (605-608). FIG. 6 is information included in the configuration information 211. The configuration management processing part 203 may keep the information in a latest state. The configuration information 211 including FIG. 6 is kept in the latest state as below. The agent processing parts (230 and 234 in the example of FIG. 2) obtains information regarding operation management IDs (603) of job computers (106 and 107 in the example of FIG. 2; there may exist a plurality of job computers), and then the configuration management processing part 203 collects via the communication processing part 207 the information regarding the operation management IDs.

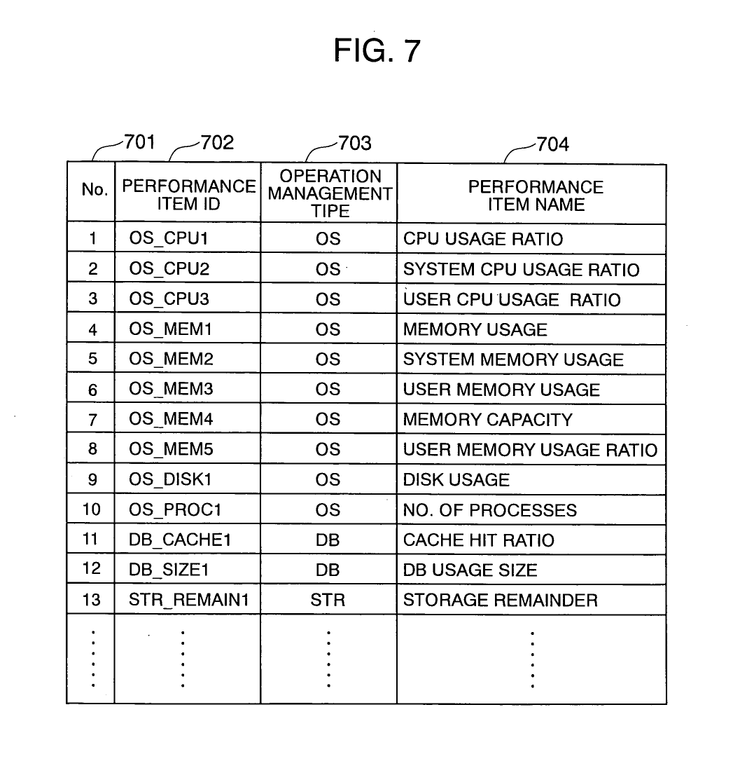

FIGS. 7 to 9 show details of the name/unit information 210.

FIG. 7 is a diagram showing an example of a performance item table of the embodiment. FIG. 7 shows a serial number. FIG. 7 shows a table to keep performance item names 704 commonly used irrespectively of the operation management.

To each performance item name, a performance item ID 702 is assigned. When the performance item ID 702 is determined, one performance item name 704 is uniquely determined. By an operation management type 703, it is possible to identify operation management associated with the performance item. For example, in the case of a performance item indicated as No. 1 for which the performance item ID is OS_CPU1, the operation management type 703 is OS, and hence it is known that the performance item is used for OS management. It is also known that the performance item name 704 is “CPU usage ratio”. Depending on operation management schemes, there may exist entries which have the same performance item and which have different names such as “CPU usage ratio” and “CPU utilization” in some cases. By using the common performance item name of FIG. 7, the operation management schemes can be treated in a unified manner without paying attention to the difference between the operation management schemes.

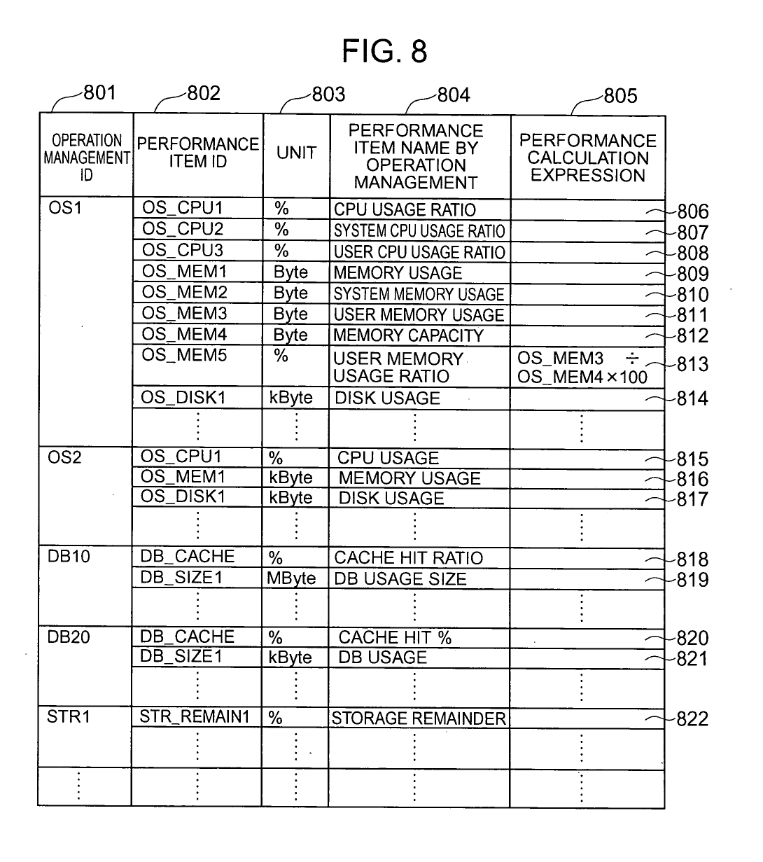

FIG. 8 is a diagram showing an example of the information table by operation management of the embodiment. FIG. 8 shows a table to keep a unit and a performance item name unique to each operation management product.

Each entry of the table includes an operation management ID 801, a performance item ID 802, a unit 803, a performance item name by operation management 804, and a performance calculation expression 805. By establishing a correspondence between the performance item ID 802 and the performance item ID 702 of FIG. 7, there can be conducted a conversion into a common name. This makes it possible to absorb difference between the performance item names of the respective operation products. For a performance item which does not exist in an operation management product and which can be calculated using another performance item, a calculation expression of the calculation is kept in the performance calculation expression 806-822 to conduct the calculation according to necessity. For example, there exists a case in which, OS_MEM5 can be calculated using OS_MEM3 and OS_MEM4 as indicated by the performance calculation expression (813). The item identification information and the unit can be converted according not only to a one-to-one correspondence but also to a one-to-n correspondence.

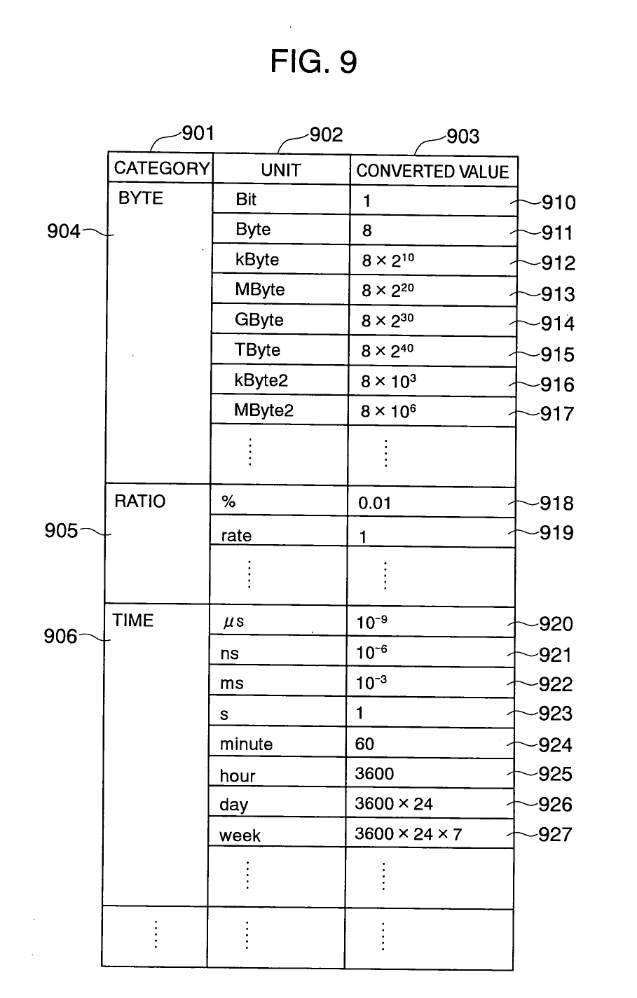

FIG. 9 is a diagram showing an example of the unit conversion table of the embodiment. FIG. 9 shows a table keeping conversion rules to convert units. Each entry of the table includes a category 901, a unit 902, and a converted value 903.

The table includes data items according to categories 901 such as a byte unit 904 indicating size, a unit of percentage 905 of a ratio, and a time unit 906 representing a unit of time, e.g., a second or a minute. In each category, a unit is determined as a reference, and a magnification factor to convert a value in the units into a value in the reference units is kept in the converted value 910-927.

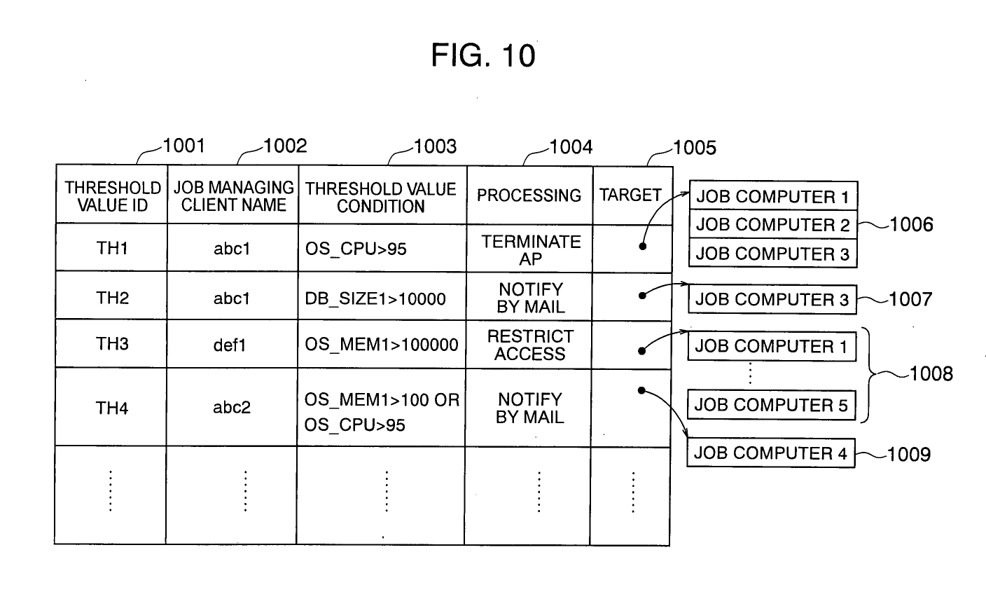

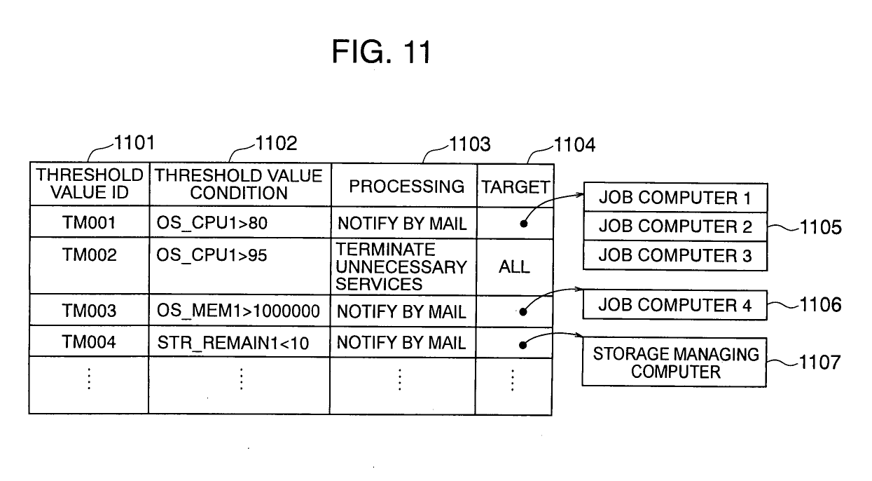

FIG. 10 is a diagram showing an example of a job threshold value table of the embodiment. FIG. 11 is a diagram showing an example of a system management threshold value table of the embodiment. FIGS. 10 and 11 show the policy information 212. The policy information 212 is information used by the policy control processing part 205. FIG. 10 (FIG. 11) indicates operation in which when a value of an item identified by the performance item ID matches a threshold value condition 1003 (1102) set as the policy information, processing 1004 (1103) corresponding to the performance item ID is executed.

FIG. 10 shows a table to keep policy information set by the job managing client 102. Each entry of the job threshold value table includes a threshold value ID 1001 to identify policy information set by the job managing client 102, a job managing client name 1002 indicating a name of the job managing client 102, a threshold value condition 1003 indicating a logical expression to determine whether or not the threshold value satisfies a predetermined condition, processing 1003 indicating the contents of processing to be executed when the threshold value condition 1003 is satisfied, and a target 1005 indicating a computer to execute the processing 1004 when the threshold value condition 1003 is satisfied.

The policy information of the job threshold value table is valid for job computer(s) (1006-1009) designated by the target 1005. When the job computer as the target satisfies the threshold value condition 1003, the job computer executes the processing 1004 and notifies threshold value exceeded indicating that the threshold value is exceeded to the job managing client name 1002. As in the threshold value condition 1003 for which the threshold value ID 1001 has a value of TH4, the threshold value condition 1003 may include a plurality of performance items using an AND condition and an OR condition.

FIG. 11 shows a table to keep the policy information set by the system managing client 101. Each entry of the system management threshold value table includes a threshold value ID 1101 to identify policy information set by the system managing client 101, a threshold value condition 1102 indicating a logical expression to determine whether or not a threshold value satisfies a predetermined condition, processing 1103 indicating the contents of processing to be executed when the threshold value condition 1102 is satisfied, and a target 1104 indicating a computer to execute the processing 1103 when the threshold value condition 1102 is satisfied.

It is assumed that the policy information of the system management threshold value table is valid for one of the job computers 106 to 108 (1105, 1106) and the storage managing computer 105 (1107) designated in the target 1104. If ALL is specified, the policy information is valid for all computers managed by the managing computer 103. If the computer designated in the target 1104 satisfies the threshold condition 1102, the computer executes the processing 1103 and notifies “threshold value exceeded” to the system managing client 101.

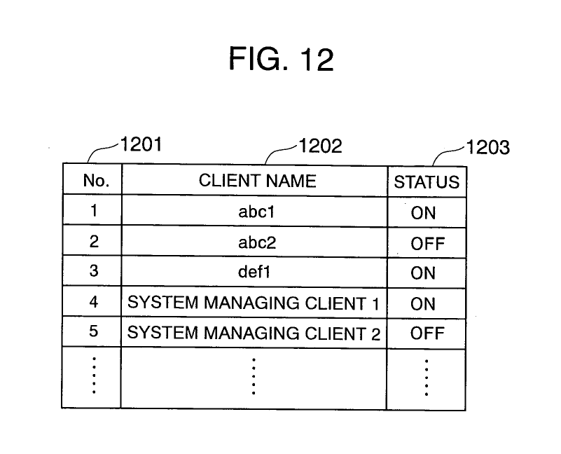

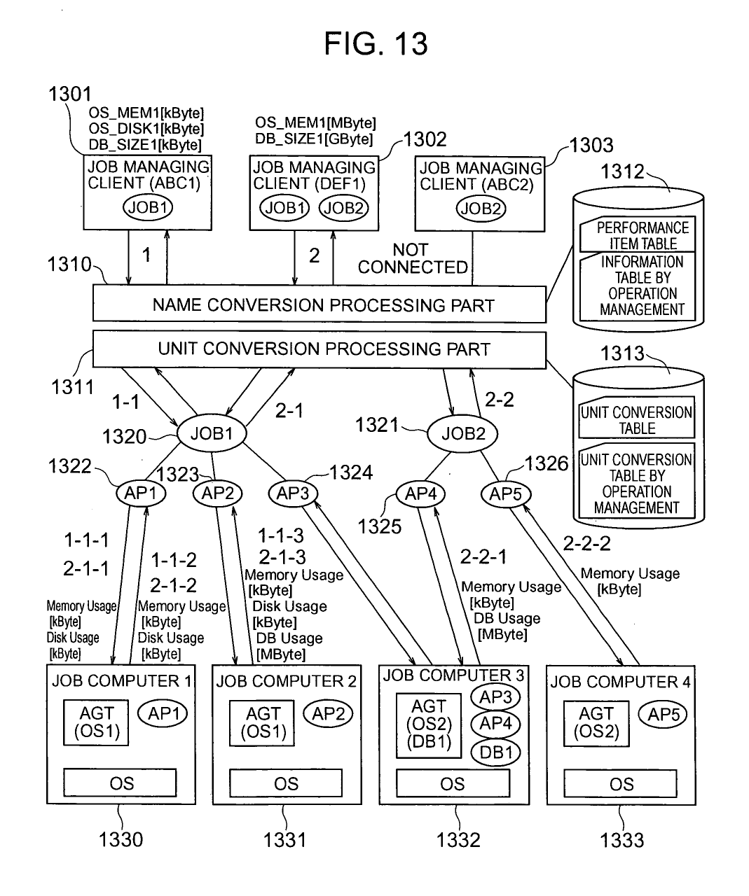

FIG. 12 shows an example of the client managing table of the embodiment. 1201 shows a serial number. FIG. 12 shows details of client managing information 213. In the table, the state of connection to the managing computer 103 is automatically kept in the latest state for each job managing client and each system managing client. Only the client for which the connection state is ON may receive an event set by the policy.

FIG. 13 is a diagram showing a flow of conversion processing of the embodiment. FIG. 13 shows an outline of the conversion processing.

A job managing client abc1 (1301) manages a job 1 and requests to notify a memory usage (OS_MEM1) in kilobyte units (kByte), a disk usage (OS_DISK1) in kilobyte units (kByte), and database usage size (DB_SIZE1) in kilobyte units (kByte; 1). A job managing client def1 (1302) manages the job 1 and a job 2 and requests a memory usage (OS_MEM1) in Megabyte units (MByte) and database usage size (DB_SIZE1) in Gigabyte units (GByte; 2). A job managing client abc2 (1303) manages the job 2, but is not connected to the managing computer 103 in the current state.

According to the job table of FIG. 4, the job 1 (1320) includes job applications AP1, AP2, and AP3 (1322-1324) which are operating on the job computers 1, 2, 3 (1330-1332), respectively. The job 2 (1321) includes job applications AP4 and AP5 (1325, 1326) which are operating on the job computers 3 and 4 (1332, 1333), respectively. On the job computer 3 (1332), DB1 to be shared between the jobs 1 and 2 (1320, 1321) are operating.

Next, description will be given of the conversion of the performance item name and the unit when performance information is received from the job managing client. For the request (1) from the job managing client abc1, there is used a common performance item name (performance item ID) as stored in the performance item table of FIG. 7 (1312). First, a name conversion processing part converts the performance item name into a name conforming to the operation managing agent of each job computer used by the job 1. The unit of the job managing client abc1 is beforehand stored in a memory so that a unit conversion processing part converts the unit into a unit conforming to the operation managing agent of each job computer (1313).

According to the computer operation managing table of FIG. 6, the agent of OS1 is operating on the job computers 1 (1330) and 2 (1331). Therefore, the conversion is conducted into an item name for which the operation management ID is OS1 in the information table by operation management of FIG. 8. In this situation, the memory usage (OS_MEM1) and the disk usage (OS_DISK1) are converted into “Memory Usage” and “Disk Usage”, respectively (1-1-1). This is also the case with the job computer 2 (1-1-2). For the job computer 3 (1332), since the agent of OS2 is operating thereon, the conversion is conducted into an item name for which the operation management ID is OS2 in the information table by operation management of FIG. 8. In this situation, the memory usage (OS_MEM1) and the disk usage (OS_DISK1) are converted into “Memory Usage” and “Disk Usage”, respectively (1-1-3). Since DB1 is operating on the job computer 3, the DB size (DB_SIZE1) is also requested. According to FIG. 8, the performance item name is converted into “DB usage Size” and a request is issued to the job computer 3.

Description will be given to the conversion of the performance item name and the unit when the performance information sent from the agent is notified to the client. As opposed to the operation to request performance information, the item name and the unit of each operation management are converted into a common item name (item ID) and a unit designated by the client. For example, as a result of the request in 1-1-1, a memory usage and a disk usage are returned in units of bytes (Byte) and kbytes (kByte), respectively. According to FIG. 8 and the condition that OS1 is operating on the job computer 1, it is known that the performance item IDs of the memory usage and the disk usage are OS_MEM1 and OS_DISK1, respectively. According to FIG. 7 and the obtained performance item IDs, the conversion results in the common performance item names respectively thereof, i.e., “Memory Usage” and “Disk Usage”, respectively. The respective units are converted into units of kbytes (kByte) designated by the client. The converted data is passed to the client.

Through the above procedure, the manager processing part can obtain, according to a request from at least one client, performance information having a name and a unit requested by the client. That is, for a name and a unit requested by a job manager operating the job managing client, the name and unit possessed by the operation management may be virtualized.

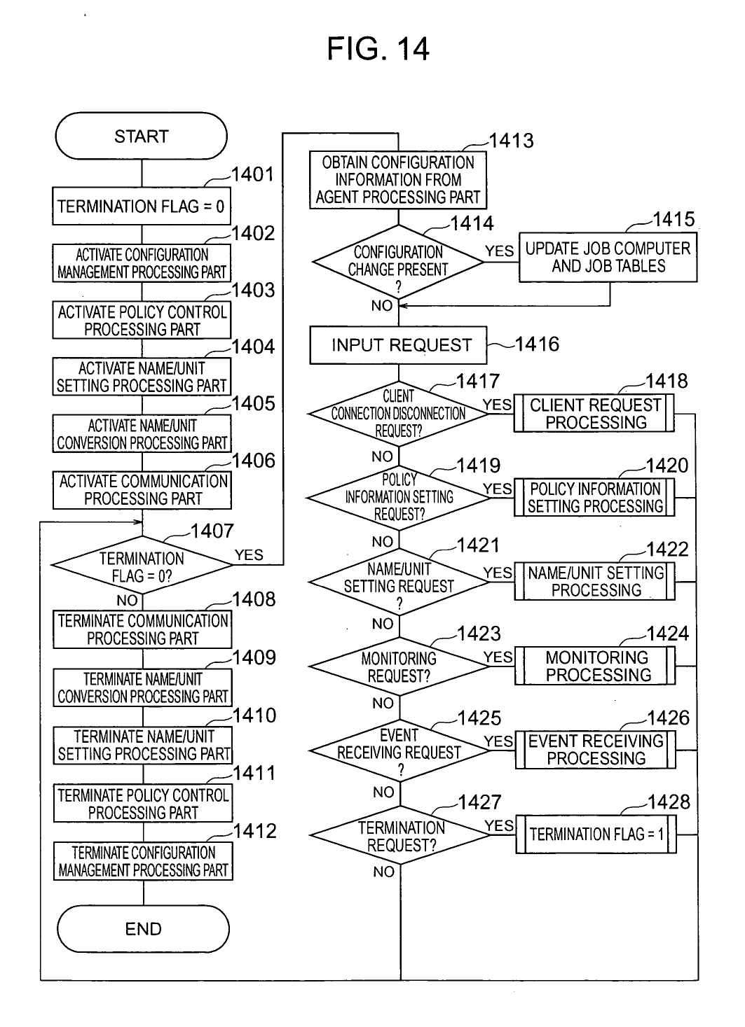

FIG. 14 is a flowchart showing a processing procedure of the main processing of the embodiment. As shown in FIG. 14, the manager processing part 201 of the managing computer 103 of the embodiment first stores “0” in a termination flag in the memory to thereby initialize the termination flag (1401) and activates the configuration management processing part 203 (1402), the policy control processing part 205 (1403), the name/unit setting processing part 204 (1404), the name/unit conversion processing part 206 (1404), and the communication processing part 207 (1406).

Next, the manager processing part 201 checks the contents of the termination flag in step 1407 and repeatedly executes request processing as follows. First, before the request processing, the manager processing part 201 obtains, by a communication device, configuration information of the storage managing computer 105 and the job computers 106 to 108 from the agent processing parts respectively of the computers 105 to 108 (1413). The manager processing part 201 compares the obtained configuration information with the previous configuration information, and updates the computer managing table (FIG. 3) and the job table (FIG. 4) if the configuration has been updated (1414, 1415).

Next, the manager processing part 201 receives by a communication device an input of a request from one of the system managing client 101, the job managing client 102, the storage managing computer 105, and the job computers 106 to 108 (1416) and executes processing according to the request.

If the received request is a client connection request from the system managing client 101 or the job managing client 102 (1417), the manager processing part 201 executes client request processing (1418). If the request is a policy information setting request (1419), the manager processing part 201 executes policy information setting processing (1420). If the request is a name/unit setting request (1421), the manager processing part 201 executes name/unit setting processing (1422). If the request is a monitoring request (1423), the manager processing part 201 executes monitoring processing (1424).

If the received request is an event receiving request from one of the storage managing compute 105 and the job computers 106 to 108 (1425), the manager processing part 201 executes event receiving processing (1426). If the received request is a termination request (1427), the manager processing part 201 stores “1” in the termination flag in the memory (1428).

If the termination flag is “1” as a result of the check of the contents of the termination flag in step 1407, the manager processing part 201 executes termination processing as follows. That is, the manager processing part 201 terminates the communication processing part 207 (1408), the name/unit conversion processing part 206 (1409), the name/unit setting processing part 204 (1410), the policy control processing part 205 (1411), and the configuration management processing part 203 (1412).

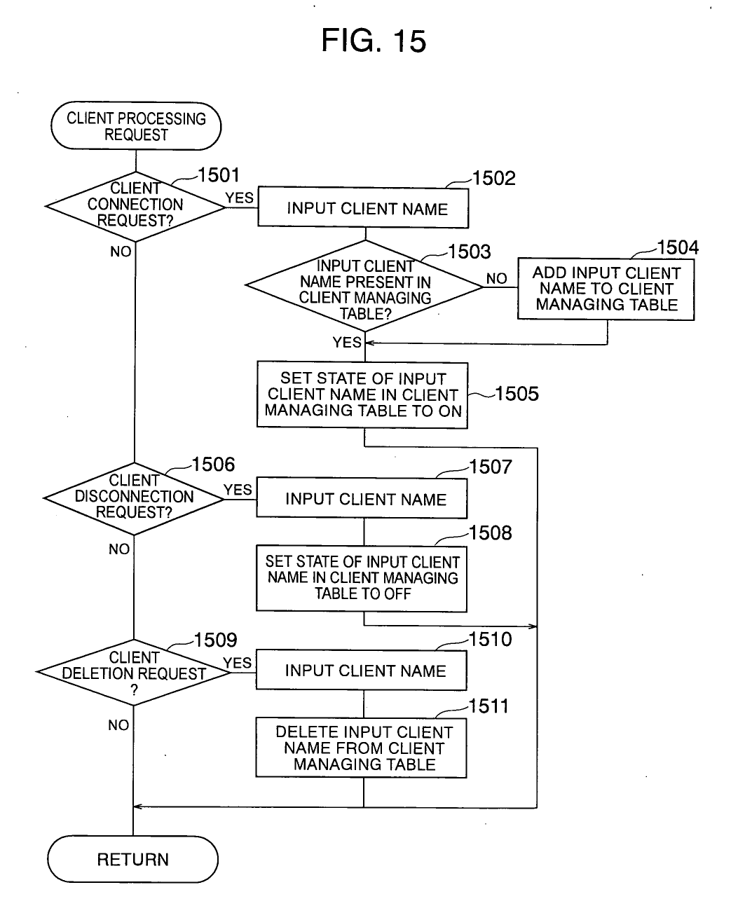

FIG. 15 is a flowchart showing a processing procedure of the client request processing of the embodiment. FIG. 15 shows details of the client request processing in step 1418 of FIG. 14.

In step 1501, the configuration management processing part 203 of the managing computer 103 checks the contents of the client request received by a communication device from the system managing client 101 or the job managing client 102 and receives as an input, if the client request is a client connection request, a client name from the client request (1502). The configuration management processing part 203 then makes a check to determine whether or not the inputted client name exists in the client managing table (FIG. 12; 1503). If the inputted client name does not exist in the client managing table (FIG. 12), the configuration management processing part 203 adds the inputted client name to the client managing table (FIG. 12) (1504) and sets the state of the client to ON (1505). If the inputted client name exists in the client managing table (FIG. 12), the configuration management processing part 203 sets the state of the input client name to ON (1505).

On the other hand, if the client request is a client disconnection request as a result of the check of the contents of the client request in step 1506, the configuration management processing part 203 receives as an input a client name from the client request (1507) and sets the state of the inputted client name in the client managing table (FIG. 12) to OFF (1508).

If the client request is a client deletion request as a result of the check of the contents of the client request in step 1509, the configuration management processing part 203 receives as an input a client name from the client request (1510) and then deletes the row of the inputted client name from the client managing table (1511).

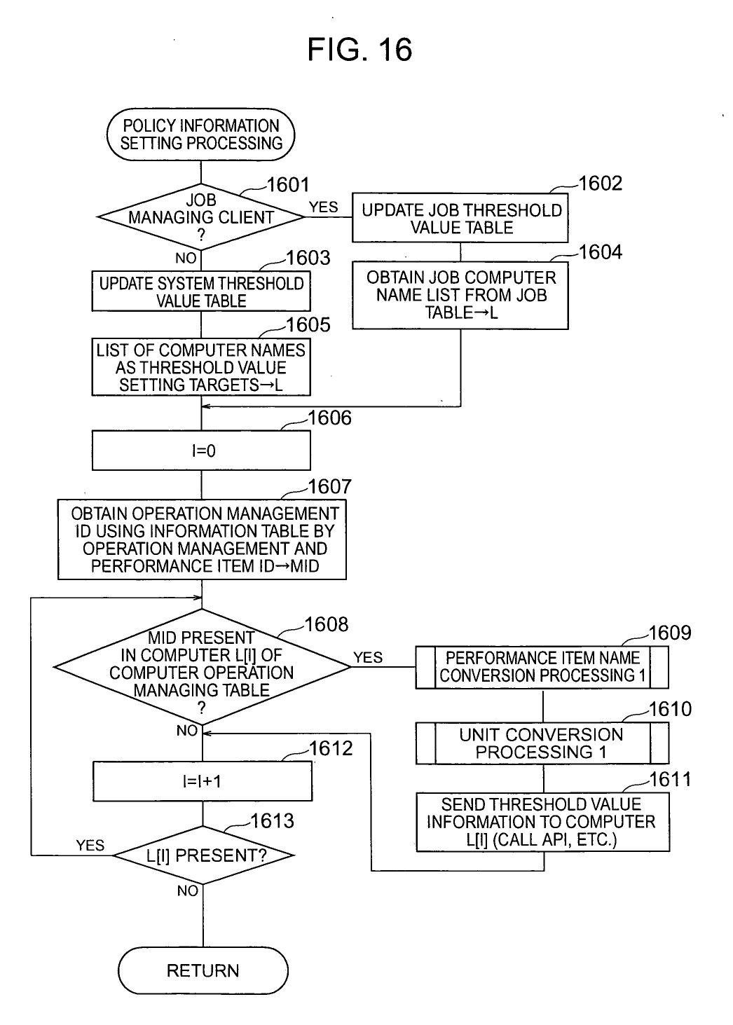

FIG. 16 is a flowchart showing a processing procedure of the policy information setting processing of the embodiment. FIG. 16 shows details of the policy information setting processing in step 1420 of FIG. 14.

First, the policy control processing part 205 of the managing computer 103 makes a check to determine whether or not a client having issued a policy setting request is the job managing client 102 (1601). In the processing, the policy control processing part 205 checks a name of the client having issued the policy setting request. If the client name includes a character string of “system managing client”, it is determined that the client is the system managing client 101. If the client name does not include the character string, it is determined that the client is the job managing client 102.

If the client having issued the policy setting request is the job managing client 102, the policy control processing part 205 updates the job threshold value table (FIG. 10; 1602) and obtains list L of job computers from the job table (1604). If the client having issued the policy setting request is not the job managing client 102, the policy control processing part 205 updates the system threshold value table (FIG. 11; 1603) and obtains list L of job computers as threshold value setting targets (1605).

Next, the policy control processing part 205 stores “0” in variable I in the memory to initialize variable I (1606), retrieves a performance item ID 802 matching the performance item ID in the policy information using the information table by operation management, and obtains an operation management ID 801 from an associated row to store the operation management ID 801 in variable MID in the memory (1607).

The policy control processing part 205 then executes processing as many times as there are elements of computer list L as below. That is, the policy control processing part 205 makes a check to determine whether or not there exists an operation management ID corresponding to job computer L[I] in the computer operation managing table, the operation management ID matching MID (1608). If there exists such an operation management ID, the policy control processing part 205 executes the performance item name conversion processing 1 (1609) and the unit conversion processing 1 (1610). Through the processing, the common item name (item ID) can be converted into an item name of job computer L[I] and the unit can be converted into a unit unique to job computer L[I]. Using the converted data, the policy control processing part 205 sends threshold value information to job computer L[I] (1611). After adding “1” to variable I, the policy control processing part 205 executes similar processing also for the next L[I] (1608 to 1613).

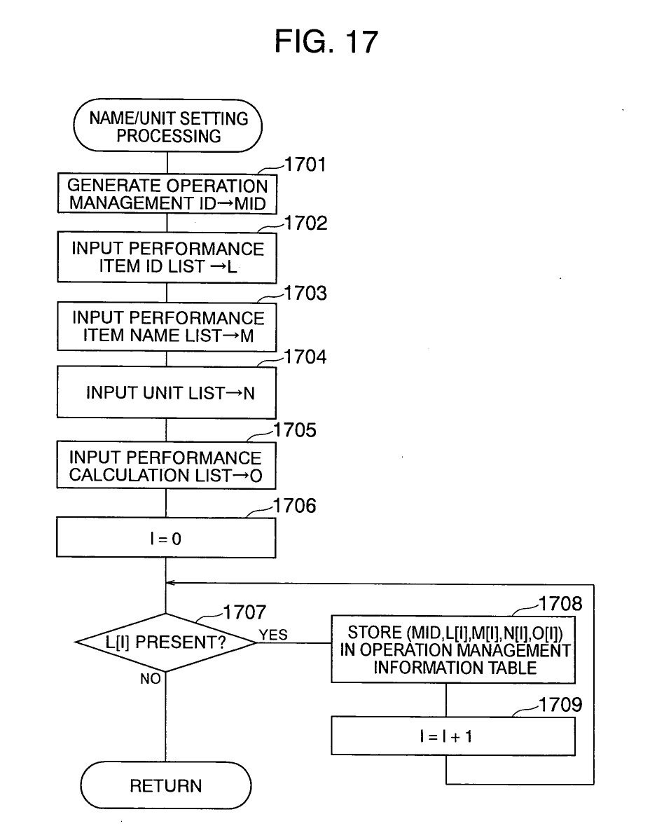

FIG. 17 is a flowchart showing a processing procedure of the name/unit setting processing of the embodiment. FIG. 17 shows details of the name/unit setting processing in step 1422 of FIG. 14. The name/unit setting processing executes this processing, for example, when new operation management is added.

The name/unit setting processing 204 of the managing computer 103 first generates and stores an operation management ID in MID (1701). Next, the name/unit setting processing 204 receives inputs of a performance item ID list, a list of performance item names, a list of units for the performance item names, and a performance calculation expression list to store the lists in lists L, M, N, and O, respectively (1702 to 1705). The name/unit setting processing part 204 adds (MID, L[I], M[I], N[I], O[I]) to the operation management information table (FIG. 8) according to the number of performance items (1706 to 1709).

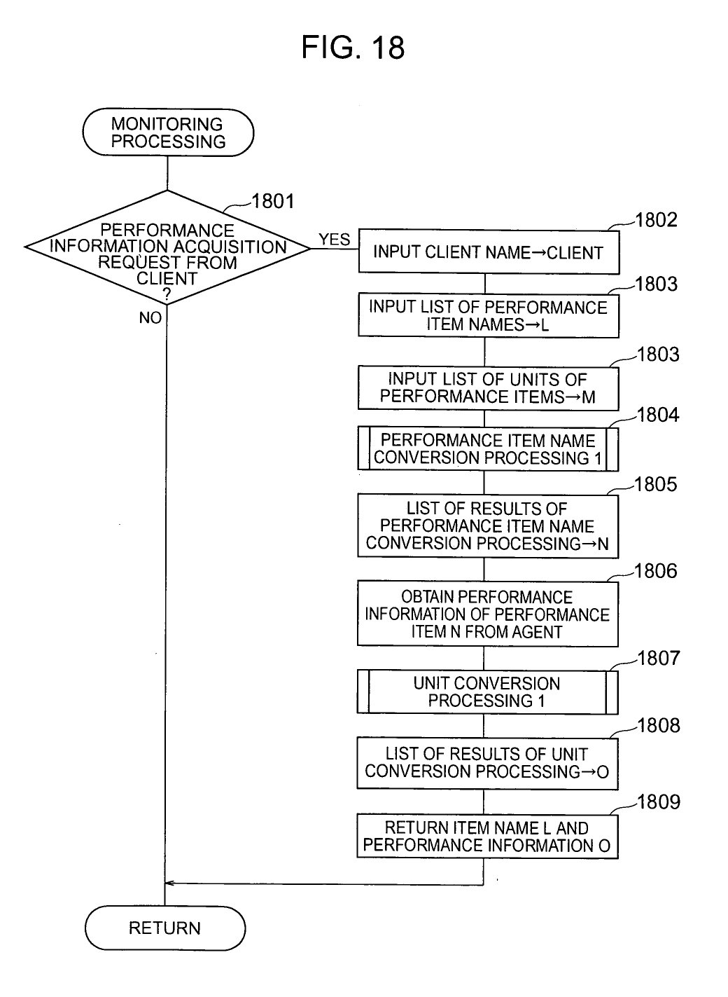

FIG. 18 is a flowchart showing a processing procedure of the monitoring processing of the embodiment. FIG. 18 shows details of the monitoring processing in step 1424 of FIG. 14.

The manager processing part 201 of the managing computer 103 receives, when there exists a performance information acquisition request from a client (1801), an input of a client name (1802) and inputs of a list of performance item names and a list of units for the performance item names to store the lists in lists L and M (1803 and 1804). The manager processing part 201 executes the performance item name conversion processing 1 (1804) for list L to store a conversion result in list N (1805). Next, the manager processing part 201 obtains entire performance information of performance item list L (1806) to convert each unit of the obtained performance information (1807). The manager processing part 201 stores the converted performance information in list O (1808) and returns a combination of item name L and performance information O (1809).

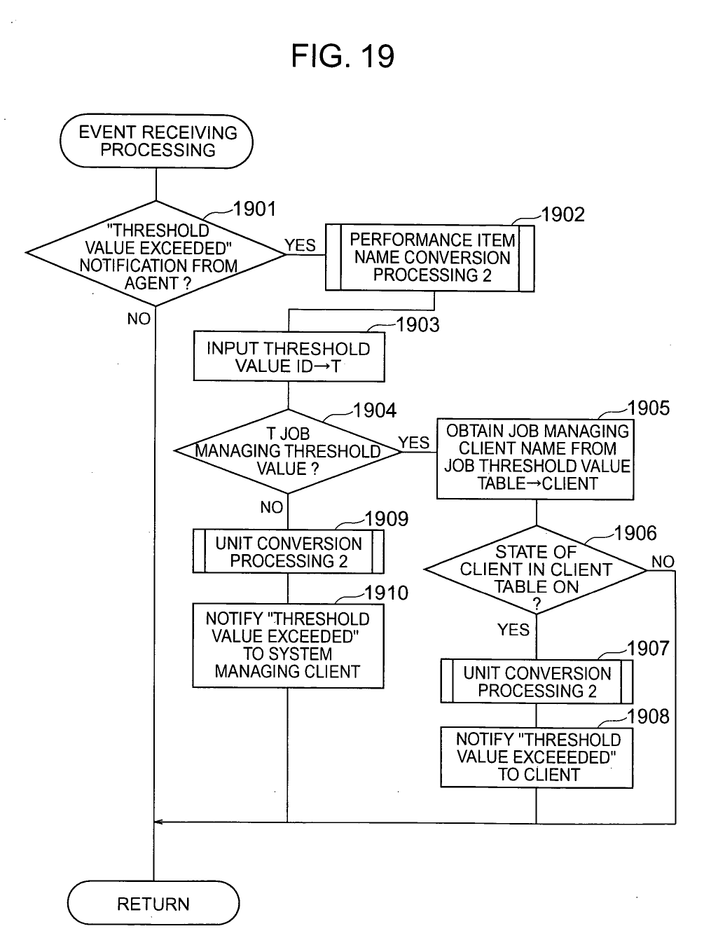

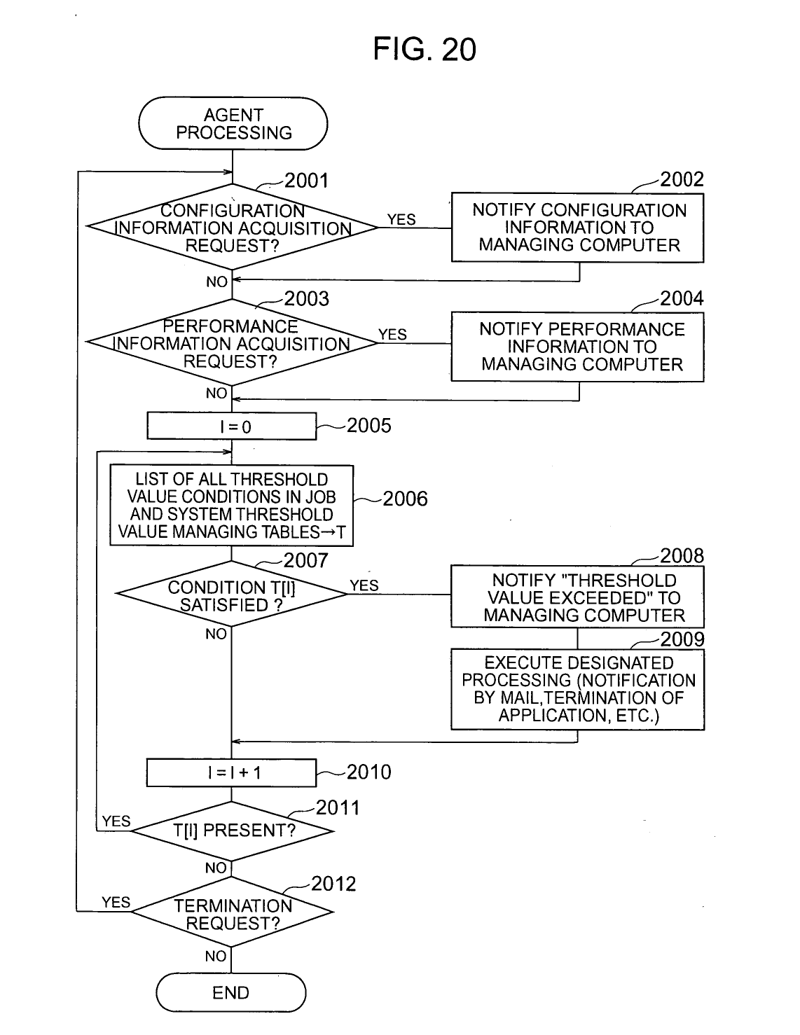

FIG. 19 is a flowchart showing a processing procedure of the event receiving processing of the embodiment. FIG. 19 shows details of the event receiving processing in step 1426 of FIG. 14.

The manager processing part 201 of the managing computer 103 converts, when there exists a “threshold value exceeded” notification from an agent (1901), item names regarding performance information as information associated with the “threshold value exceeded” notification into common item names (1902). The manager processing part 201 stores a threshold value ID associated with the “threshold value exceeded” notification in variable T (1903). When T is a job threshold value (1904), the manager processing part 201 obtains from the job threshold value table (FIG. 10) a job managing client name 1002 of a row for which T matches with the threshold value ID 1001 and then stores the job managing client name 1002 in variable CLIENT (1905). In the client table (FIG. 12), if a state 1203 of a row for which CLIENT matches with the client name 1202 is ON (1906), the manager processing part 201 converts the unit of performance information associated with the “threshold value exceeded” notification into a unit designated by CLIENT (1907) and sends the converted “threshold value exceeded” notification to CLIENT (1908). If the state 1203 is OFF, the manager processing part 201 does not send any notification to CLIENT.

On the other hand, when T is a system managing threshold value in step 1904, the manager processing part 201 converts the unit of performance information associated with the “threshold value exceeded” notification into a unit designated by the system managing client (1909) and sends the “threshold value exceeded” notification including the converted performance information to the system managing client (1910).

FIG. 20 is a flowchart showing a processing procedure of the agent processing of the embodiment. FIG. 20 shows details of the agent processing.

The storage agent processing part 220 of the storage managing computer 105 or each agent processing part of the job computers 106 to 108 notifies, when a configuration information acquisition request is received (2001), current configuration information at the current point of time to the managing computer 103 (2002).

When a performance information acquisition request is received (2003), the agent processing part notifies performance information to the managing computer 103 (2004). After “0” is set to variable I in step 2005, steps 2006 to 2011 include processing to check a threshold value, specifically, to check all threshold value conditions in the job threshold value table (FIG. 10) and the system managing threshold value table (FIG. 11); repetitious processing of 2006, 2007 to 2010, and 2011). If a threshold value condition is satisfied, the agent processing part notifies the condition to the managing computer 103 (2008) and execute processing designated in the threshold value tables of FIGS. 10 and 11, for example, processing to notify by mail or processing to terminate an application (2009). If a termination request is received (2012), the agent processing part terminates the agent processing.

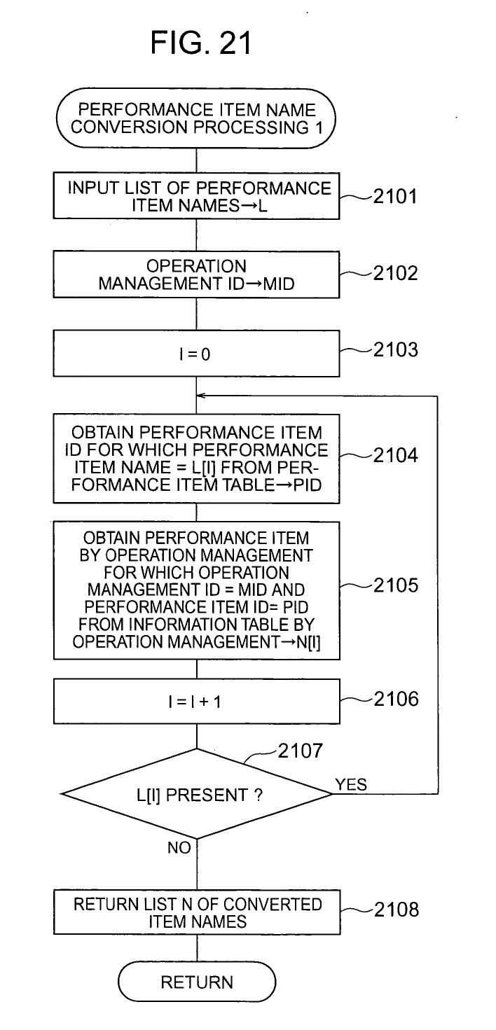

FIG. 21 is a flowchart showing a processing procedure of the performance item name conversion processing 1 of the embodiment. In the performance item name conversion processing 1 shown in FIG. 21, a common item name (item ID) is converted into an item name of each operation management.

First, the name/unit conversion processing part 206 of the managing computer 103 receives as an input a list of common performance item names (item IDs) to store the list in list L (2101). Next, the name/unit conversion processing part 206 receives an operation management ID to store the ID in MID (2102). The name/unit conversion processing part 206 sets “0” to I (2103) and converts, for each of the item names of list L, a common item name (item ID) into a performance item by operation management. For this purpose, the name/unit conversion processing part 206 retrieves a row for which L[I] matches with the performance item name 704 in the performance item table (FIG. 7) and then obtains and stores a performance item ID 702 in PID (2104). If the item received in step 2101 is a performance item ID, that is, if the performance item ID 702 of the performance item table (FIG. 7) matches with L[I], the name/unit conversion processing part 206 may store the item ID in PID.

Next, the name/unit conversion processing part 206 retrieves a row of the information table by operation management (FIG. 8) for which an operation management ID 801 matches MID and a performance item ID 802 matches PID and then obtains and stores a performance item name by operation management 804 in N[I] (2105). The name/unit conversion processing part 206 executes 2104 to 2107 for all item names (item IDs) in list L. Finally, the name/unit conversion processing part 206 returns list N of the converted item names (2108).

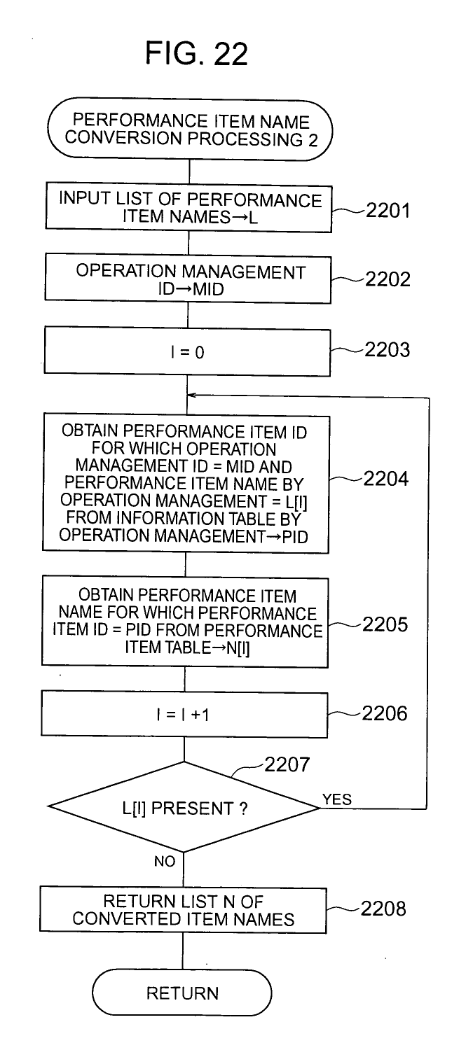

FIG. 22 is a flowchart showing a processing procedure of the performance item name conversion processing 2 of the embodiment. In the performance item name conversion processing 2 shown in FIG. 22, an item name of each operation management is converted into a common item name (item ID).

First, the name/unit conversion processing part 206 of the managing computer 103 receives as an input a list of performance item names by operation management to store the list in list L (2201). Next, the name/unit conversion processing part 206 receives an operation management ID to store the ID in MID (2201). The name/unit conversion processing part 206 sets “0” to I (2203) and converts, for each of the item names of list L, a performance item name by operation management into a common item name (item ID). For this purpose, the name/unit conversion processing part 206 retrieves from the information table by operation management (FIG. 8) a row for which an operation management ID 801 matches MID and for which L[I] matches with the performance item name by operation management 804 and then obtains and stores a performance item ID 802 in PID (2204). Next, the name/unit conversion processing part 206 retrieves a row from the performance item table (FIG. 7) for which a performance item ID 702 matches PID and then obtains and stores a common performance item name 704 in N[I] (2205). The name/unit conversion processing part 206 executes 2204 to 2207 for all item names in list L. Finally, the name/unit conversion processing part 206 returns list N of the converted item names (2208). In the processing, the name/unit conversion processing part 206 may return a common item ID, i.e., the obtained performance item ID 802 in place of the common item name.

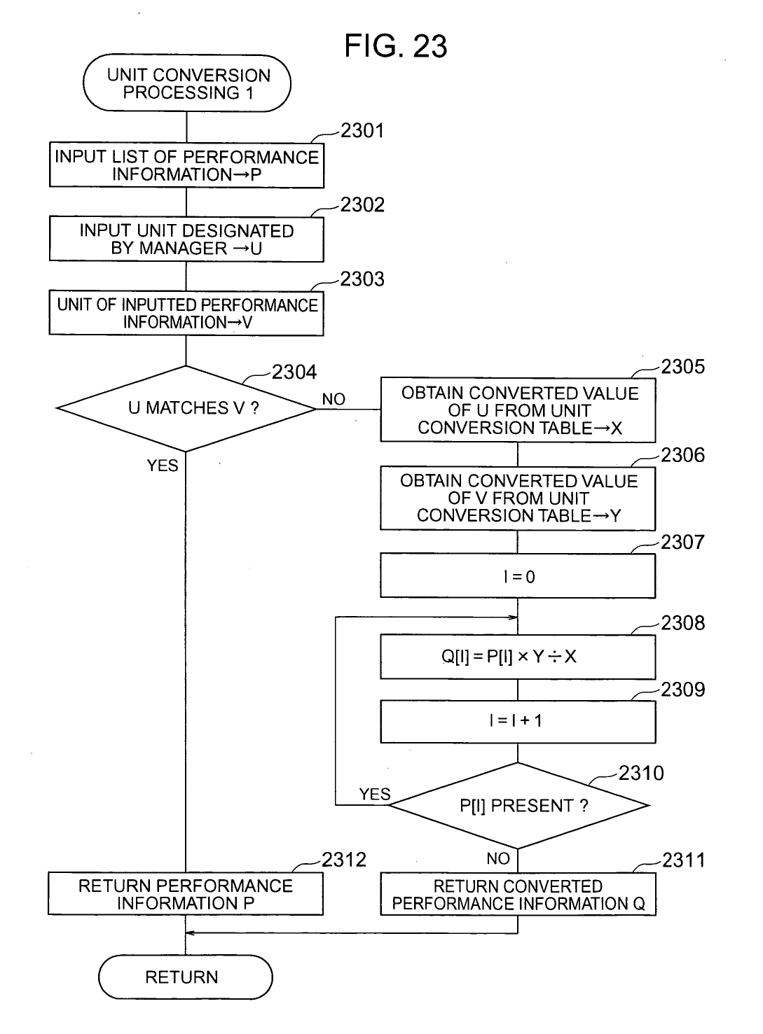

FIG. 23 is a flowchart showing a processing procedure of the unit conversion processing 1 of the embodiment. In the unit conversion processing 1 shown in FIG. 23, a unit of each client is converted into a unit of each operation management.

First, the name/unit conversion processing part 206 of the managing computer 103 receives as an input a list of performance information to store the list in list P (2301). Next, the name/unit conversion processing part 206 receives a unit designated by the manager and a unit of the performance information to store the units in U and V, respectively (2302 and 2303). If the unit of U matches that of V (2304), the name/unit conversion processing part 206 returns the performance information (2312). If the unit of U does not match that of V, the name/unit conversion processing part 206 obtains converted values of U and V from the unit conversion table (FIG. 9) to store the converted values in X and Y, respectively (2305 and 2306). The name/unit conversion processing part 206 sets “0” to variable I (2307) and conducts a calculation of “P[I]×Y÷X” for each performance information P[I] to store the results in Q[I] (2308 to 2310). Finally, the name/unit conversion processing part 206 returns list Q of the converted performance information (2311).

It is assumed in the description that the unit designated by the manager indicates a unit of each client beforehand designated by the manager. It is assumed that at request of performance information from each client or at activation by each client, the unit is beforehand sent from the client to the managing computer 103 and is stored in, for example, a memory.

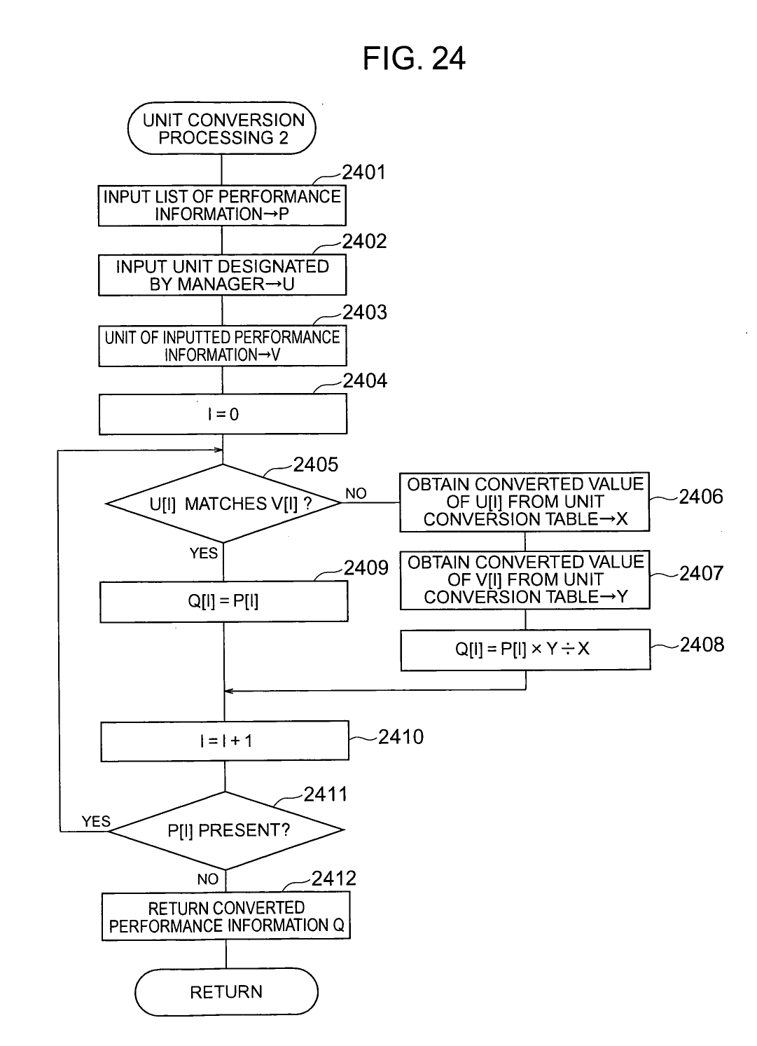

FIG. 24 is a flowchart showing a processing procedure of the unit conversion processing 2 of the embodiment. In the unit conversion processing 2 shown in FIG. 24, a unit of each operation management is converted into a unit of each client.

First, the name/unit conversion processing part 206 of the managing computer 103 receives as an input a list of performance information to store the list in list P (2401). Next, in consideration of a situation in which a conditional expression set to a threshold value of a policy includes a plurality of performance items, the name/unit conversion processing part 206 receives the performance information in the form of a list. Next, the name/unit conversion processing part 206 receives a list of units designated by the manager and a list of units of the performance information to store the lists in U and V, respectively (2402 and 2403). For all elements of performance information list P, the name/unit conversion processing part 206 converts the unit. The name/unit conversion processing part 206 assign “0” to I (2404). If U[I] matches V[I] (2405), the name/unit conversion processing part 206 stores P[I] in Q[I] (2409). If U[I] does not match V[I], the name/unit conversion processing part 206 obtains converted values of U[I] and V[I] from the unit conversion table (FIG. 9) to store the converted values in X and Y, respectively (2406 and 2407). The name/unit conversion processing part 206 conducts a calculation of “P[I]×Y÷X” to store the results in Q[I] (2408). By adding “1” to I (2410), if P[I] is present (2411), the name/unit conversion processing part 206 returns to the processing of step 2405. If P[I] is absent (2411), the name/unit conversion processing part 206 returns performance information list Q of the converted units (2412).

According to the information monitoring system of the embodiment described above, during the operation to monitor the information of a plurality of computers, item identification information and a unit in an acquisition request for performance information, performance information, or policy information to be communicated between devices are converted into item identification information and a unit of a device of a transmission destination before the item identification information and the unit are transmitted thereto. Therefore, in an environment in which a plurality of mutually different operation management schemes exist on a network, the operation management schemes can be conducted in a unified manner without paying attention to item names and units of performance information unique to the operation management schemes.

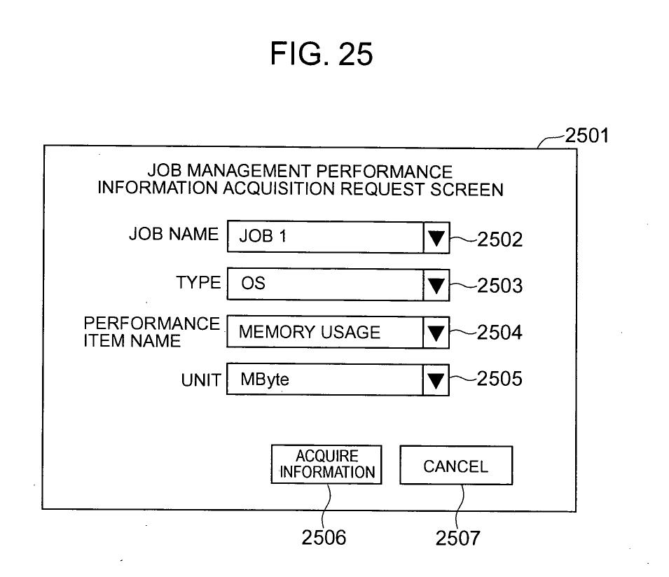

FIG. 25 is an example of a screen of the job managing client 102 used by the job manager. On the screen, when the job manager designates a job name 2502, a type 2503, a performance item name 2504, and a unit 2505 and pushes an information acquisition button 2506, it is possible to send a request to the managing computer 103 to obtain performance information of job computers and databases used in an associated job. The job manager can obtain the performance information by designating the job without paying attention to configurations of the job computers and the databases being used by the job.

It should be further understood by those skilled in the art that although the foregoing description has been made on embodiments of the invention, the invention is not limited thereto and various changes and modifications may be made without departing from the spirit of the invention and the scope of the appended claims.

1. An information monitoring method of monitoring information of a plurality of computers, comprising:
converting item identification information in an acquisition request for performance information into item identification information of a computer as a monitoring target and transmitting by a communication device a converted acquisition request thus converted to the computer as a monitoring target;
obtaining, for an item indicated by the item identification information thus converted in the converted acquisition request, performance information of the computer as a monitoring target and transmitting by a communication device the performance information to the computer as a monitoring target; and
obtaining item identification information and a unit from performance information transmitted from the computer as a monitoring target, converting the item identification information and the unit into item identification information and a unit of a device on an acquisition request side having issued the acquisition request, and transmitting by a communication device the item identification information and the unit thus converted to the device on the acquisition request side.

2. The information monitoring method according to claim 1, further comprising terminating, if a value of an item indicated by item identification information, which has been converted, satisfies a threshold value condition corresponding to the item identification information, a program corresponding to the threshold value condition.

3. The information monitoring method according to claim 1, further comprising transmitting, if a value of an item indicated by item identification information, which has been converted, satisfies a threshold value condition corresponding to the item identification information, a notification that the threshold value condition is satisfied.

4. The information monitoring method according to claim 3, further comprising converting item identification information and a unit in the notification indicating that the threshold value condition is satisfied into item identification information and a unit of a device as a notification destination of the notification.

5. The information monitoring method according to claim 3, further comprising transmitting, when communication with the device as a notification destination is in a connected state, the notification to the device as a notification destination.

6. An information monitoring system for monitoring information of a plurality of computers, comprising:
a manager processing part for converting item identification information in an acquisition request for performance information into item identification information of a computer as a monitoring target and transmitting by a communication device a converted acquisition request thus converted to the computer as a monitoring target and for converting item identification information and a unit in performance information transmitted from the computer as a monitoring target into item identification information and a unit of a device on an acquisition request side having issued the acquisition request and transmitting by a communication device the item identification information and the unit thus converted to the device on the acquisition request side; and
an agent processing part for obtaining, for an item indicated by the item identification information thus converted in the converted acquisition request, performance information of the computer as a monitoring target and transmitting by a communication device the performance information to the computer as a monitoring target.

7. An information monitoring system, wherein a computer including the manager processing part and the device on the acquisition request side are computers substantially equal to each other.

8. A program product to make a computer execute an information monitoring method of monitoring information of a plurality of computers, the program product making the computer execute:
a function to convert item identification information in an acquisition request for performance information into item identification information of a computer as a monitoring target and to transmit by a communication device a converted acquisition request thus converted to the computer as a monitoring target;
a function to obtain, for an item indicated by the item identification information thus converted in the converted acquisition request, performance information of the computer as a monitoring target and to transmit by a communication device the performance information to the computer as a monitoring target; and
a function to obtain item identification information and a unit from performance information transmitted from the computer as a monitoring target, to convert the item identification information and the unit into item identification information and a unit of a device on an acquisition request side having issued the acquisition request, and to transmit by a communication device the item identification information and the unit thus converted to the device on the acquisition request side.
